(19) United States
(12) Patent Application Publication
(10) Pub. No.: US 2011/0137675 A1
(43) Pub. Date: Jun. 9, 2011

(54) PRODUCTS AND METHODS FOR FACILITATING COMMUNICATION BETWEEN PATENTS AND CAREGIVERS

(76) Inventor: Barbara K. McLaughlin, Wellesley Hills, MA (US)

(21) Appl. No.: 12/962,981

(22) Filed: Dec. 8, 2010

Related U.S. Application Data
(60) Provisional application No. 61/267,618, filed on Dec. 8, 2009.

(51) Int. Cl. G06Q 50/00; G06Q 90/00; G06Q 10/00

(52) U.S. Cl. 705/2; 705/500

(57) ABSTRACT

The invention generally relates to products that facilitate communication between a patient and a healthcare provider and methods of use thereof. Exemplary products include paper products (e.g., cards, sets or cards, or posters), computer program products, and electronic display devices.

### RELATED APPLICATION

The present application claims the benefit of and priority to U.S. provisional patent application Ser. No. 61/267,618, filed Dec. 8, 2009, the content of which is incorporated by reference herein in its entirety.

### FIELD OF THE INVENTION

The invention generally relates to products that facilitate communication between a patient and a healthcare provider and methods of use thereof.

### BACKGROUND

Health literacy is defined as the degree to which individuals have the capacity to obtain, process, and understand basic health information and services needed to make appropriate health decisions. People with poor health literacy have less understanding of disease management, report overwhelmingly worse health status, and are not likely to seek preventative medicine or services.

Health Literacy can be impacted positively by good communications (verbally, graphically, and in writing). In some instances the reason for communication difficulty regarding health issues can be due to language barriers. Whatever the reason, the frustration level for both caregivers and care receivers can be significant and can also have serious health consequences. In addition to the personal patient costs associated with poor health literacy, it is estimated that the cost to American Healthcare is anywhere from $23-$73 Billion annually.

### SUMMARY

The present invention generally relates to communication products that are designed to assist healthcare providers in communicating with (e.g., talking to) patients with limited reading or English skills, or who otherwise may be compromised in understanding or reciprocally communicating (e.g., an intubated patient).

Aspects of the invention provide medical information products in paper form that include a first portion having a key communication, a second portion having a graphic, and a third portion having text that corresponds to the graphic. The graphic and the corresponding text facilitate communication between a healthcare provider and a patient. In certain embodiments, the first and third portions are provided in a plurality of languages.

Other aspects of the invention provide an electronic display device, the device having a processor and a visual display, the processor executing instructions of a computer program that results in the display showing: a first portion having a key communication; a second portion having a graphic, and a third portion comprising text that corresponds to the graphic. The graphic and the corresponding text facilitate communication between a healthcare provider and a patient. The device may further include a language selection prompt, then when executed by the patient displays text in the selected language. In certain embodiments, the first and third portions are provided in a plurality of languages.

The key communication may be any phrase that can be used to facilitates communication between a healthcare provider and a patient. The communication may be used to prompt the patient to provide information regarding the patient's current state of being or about a particular body part. In other embodiments, the key communication is used to inform the patient of action that will be taken by the healthcare provider or that should be undertaken by the patient. Exemplary prompts include the phrases: I need; I want; I feel; I'm here to; I hurt; Important people; I must; I must not; To stay healthy I must; and To stay healthy I must not.

The graphics will depend on the purpose of the product, and relate to the key communication associated with that product. For example, if the key communication is “I feel”, the provided graphics are graphics that are informative of the patient's state of being. An exemplary set of graphics are a set of faces, each face having a certain expression that is informative of the patient's state of being (e.g., good, bad, tired, or hot). If the key communication is “I hurt”, the provided graphics are graphics of different patient body parts that provide information regarding a state of the body part.

Products of the invention may also include a pain scale. The pain scale generally includes an ascending set of numbers, a plurality of graphics, in which each graphic correlates with an amount of pain being experienced by the patient, and text that corresponds to the graphic, which may be provided in a plurality of languages. In certain embodiments, the graphic is a face having an expression that is informative of the patient's state of pain.

In embodiments in which the product is a paper product, the paper product may be laminated so that it may be sterilized as required. Additionally, the product may include at least one member for attaching the product to an object in a patient's room (e.g., hooks, Velcro, straps, clips, or a lanyard).

Other aspects of the invention provide a computer program product for facilitating communication between a healthcare provider and a patient, the computer program product being embodied in a computer readable medium and including computer instructions to be executed by a processor to generate a visual display that includes a first portion having a key communication, a second portion having at least one graphic, and a third portion having text that corresponds to the graphic, in which the graphic and the corresponding text facilitates communication between a healthcare provider and a patient.

Other aspects of the invention provide methods for facilitating communication between a patient and a healthcare provider. Methods of the invention involve showing a patient a medical information product, the medical information product including a first portion having a key communication, a second portion having a graphic, and a third portion having text that corresponds to the graphic. The graphic and the corresponding text facilitates communication between a healthcare provider and a patient. Methods of the invention further involve using the product to facilitate communication between a healthcare provider and a patient. In certain embodiments, the medical information product is in paper form. In other embodiments, the medical information product is an electronic display device.

### BRIEF DESCRIPTION OF THE DRAWINGS

FIG. 1 is a picture showing a medical product in for facilitating communication between a patient and a healthcare provider.

FIG. 2 is a picture showing a medical product in which the communication is “I hurt” and the graphics and text are parts of the body.

FIG. 3 is a picture showing a medical product in which the communication is “To stay healthy, I must” and the graphics and text are actions to be undertaken by the patient to stay healthy.

FIG. 4 is a picture showing a medical product in which the communication is “To prevent infection, I must” or “To prevent infection, I must not”, and the graphics and text provide instructions that a healthcare provider can show a patient to help them understand the action they must undertake or refrain from undertaking in order to prevent infection.

FIG. 5 is a picture showing a medical product in which the communication is “I am here to”, and the graphics and text provide instructions that a healthcare provider can show a patient so that the patient can understand the action that will be undertaken by the healthcare provider.

FIG. 6 is a picture showing a medical product in which the communication is “I need”, and the graphics and text provide food, drink, or objects that the patient needs.

FIG. 7 is a picture showing a medical product in which the communication is “Important people”, and the graphics and text provide people that are important to the patient.

FIG. 8 is a picture showing a medical product that includes a fourth portion having a pain scale.

FIG. 9 is a set of pictures showing a medical product in which the pain scale is presented as a set of cards/screen shots.

FIG. 10 is a set of pictures showing a medical product in which the product is a set of cards/screen shots relating to a part of a patient's body that may hurt.

FIG. 11 is a set of pictures showing a medical product in which the product is a set of cards/screen shots relating to the patient's overall state of being.

FIG. 12 is a set of pictures showing a medical product in which the product is a set of cards/screen shots relating to things that may be needed by a patient.

### DETAILED DESCRIPTION

The invention generally relates to products (e.g., paper products, computer program products, and electronic display devices) that facilitate communication between a patient and a healthcare provider and methods of use thereof. Products of the invention are particularly useful for assisting healthcare providers in communicating with (e.g., talking to) patients with limited reading or English skills, or who otherwise may be compromised in understanding or reciprocally communicating (e.g., an intubated patient). A healthcare provider refers to anyone that assists in providing care to a patient. The healthcare provider may be a family member, a friend, or a trained professional. The trained professional may be a home healthcare provider or one that works in a facility, such as a hospital, nursing home, rehabilitation facility, assisted living facility, or a doctor's office.

In certain embodiments, products of the invention are paper products (e.g., cards or sets of cards). In other embodiments, products of the invention are electronic display devices. Generally, the electronic display device will include a display screen and a processor. Exemplary electronic display devices include computers (desktop and laptop); cell phones (such as the iPhone, Droid phones, or Blackberry); or tablet computers (such as the iPad).

In particular embodiments, the product is a computer program product. In certain embodiments, the computer program product is for facilitating communication between a healthcare provider and a patient, the computer program product being embodied in a computer readable medium and including computer instructions to be executed by a processor to generate a visual display that includes a first portion having a key communication, a second portion having at least one graphic, and a third portion having text that corresponds to the graphic, in which the graphic and the corresponding text facilitates communication between a healthcare provider and a patient. In more particular embodiments, the product is an Application that can run on a cell phone, such as an App for an iPhone, Droid phone, or Blackberry.

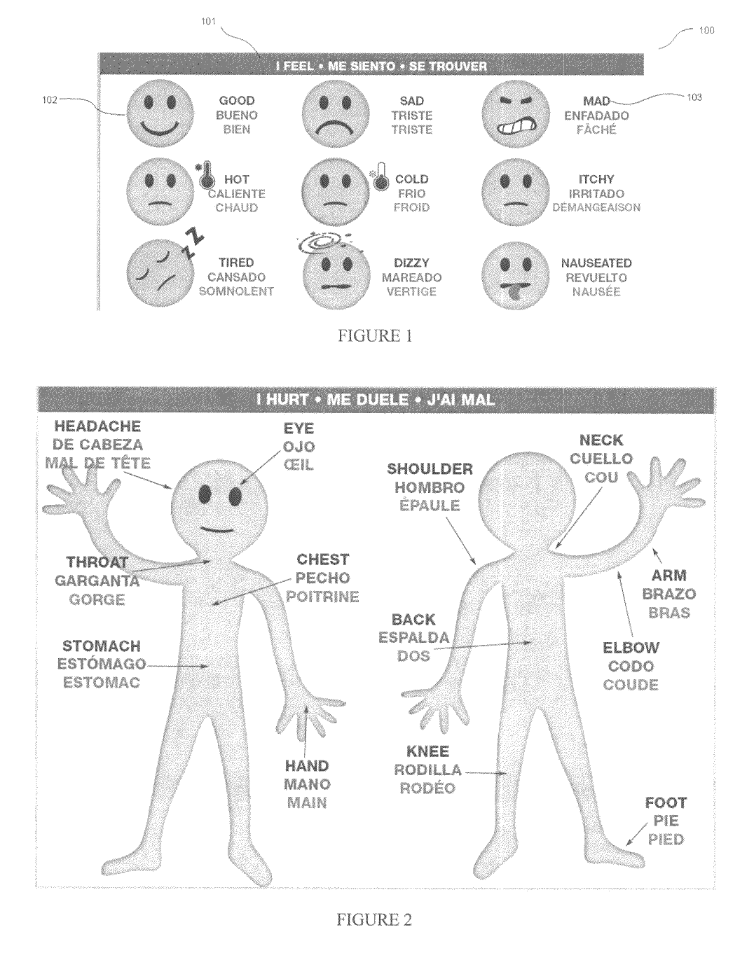

Reference is now made to FIG. 1, which shows a medical information product 100. The product 100 includes a first portion having a key communication 101, a second portion having a graphic 102, and a third portion having text 103 that corresponds to the graphic 102. The key communication 101, graphic 102, and corresponding text 103 facilitate communication between a healthcare provider and a patient.

The key communication 101 is generally a phrase. The phrase may be any phrase that can be used to facilitates communication between a healthcare provider and a patient. The communication may be used to prompt the patient to provide information regarding the patient's current state of being or about a particular body part. In other embodiments, the key communication is used to inform the patient of an action that will be taken by the healthcare provider or that should be undertaken by the patient. Exemplary prompts include the phrases: I need; I want; I feel; I'm here to; I hurt; Important people; I must; I must not; To stay healthy I must; and To stay healthy I must not. Phrases can be tailored to elicit specific responses based on symptoms or problems known to be associated with the patient, such as certain diseases. For example, the prompts may be tailored to elicit disease specific information from a patient suffering from arthritis, lung disease, diabetes, burns, or cancer.

Graphic 102 and corresponding text 103 provide a response or answer to the key communication 101, thereby facilitating communication between the patient and the healthcare provider. In FIG. 1, the possible responses to the key communication 101 “I feel” include the answers: good, sad, hot, cold, tired, or dizzy. Each answer includes a graphic 102 and corresponding text 103. The graphics in FIG. 1 are illustrated as faces having a certain expression that is informative of the patient's state of being (e.g., good, sad, hot, cold, tired, or dizzy). To further facilitate communication and to eliminate or reduce ambiguity between the patient and the healthcare provider, the graphic 102 is accompanied by text 103 that corresponds to the graphic 102. Depending on the design of the product, it can include more or less answers to the key communication. For example, the product 100 could include additional answers to the prompt “I feel” such as: hungry; scared; or excited.

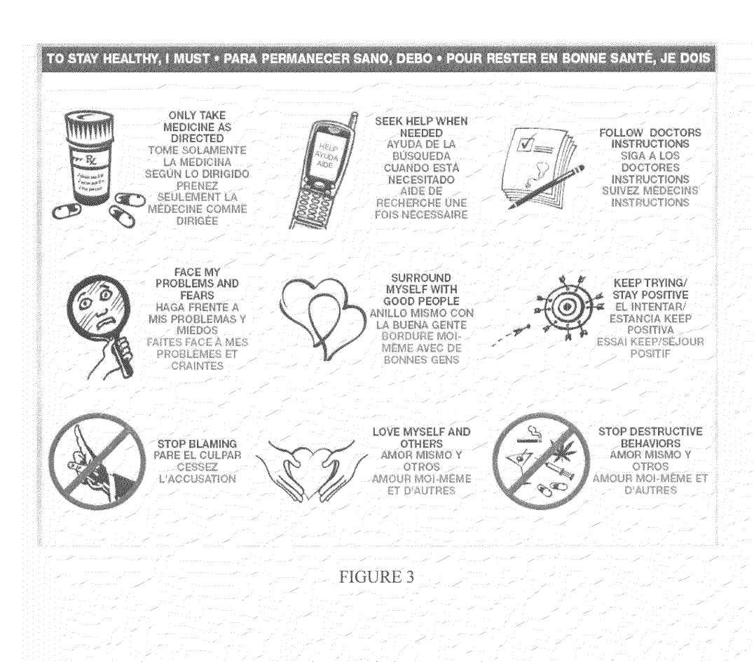

The key communication 101 will determine what type of graphics 102 and text 103 are provided. For example, if the key communication is “I hurt”, then the graphic and text may be of a patient's body parts (FIG. 2). FIG. 3 provides an example in which the key communication is “To stay healthy, I must”, and the graphics and text provide answers that a healthcare provider can show a patient to help them understand the action they must undertake to stay healthy. Exemplary actions include only taking medicine when needed or seeking help as needed. Other exemplary answers are provided in FIG. 3.

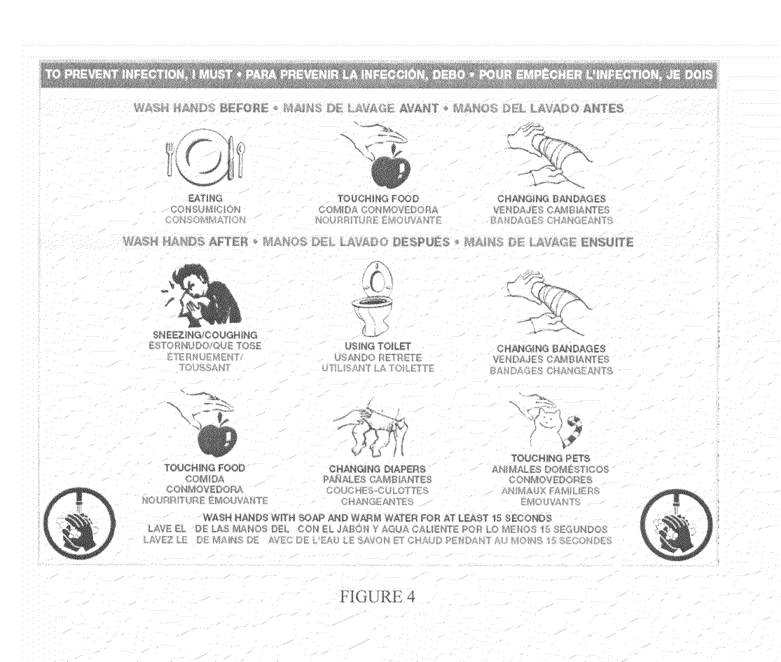

FIG. 4 provides an example in which the key communications are “To prevent infection, I must” or “To prevent infection, I must not”, and the graphics and text provide instructions that a healthcare provider can show a patient to help them understand the action they must undertake or refrain from undertaking in order to prevent infection. Exemplary actions to undertake include washing hands before eating and washing hands after using the toilet. Exemplary actions to refrain from include touching a wound. Other exemplary answers are provided in FIG. 4.

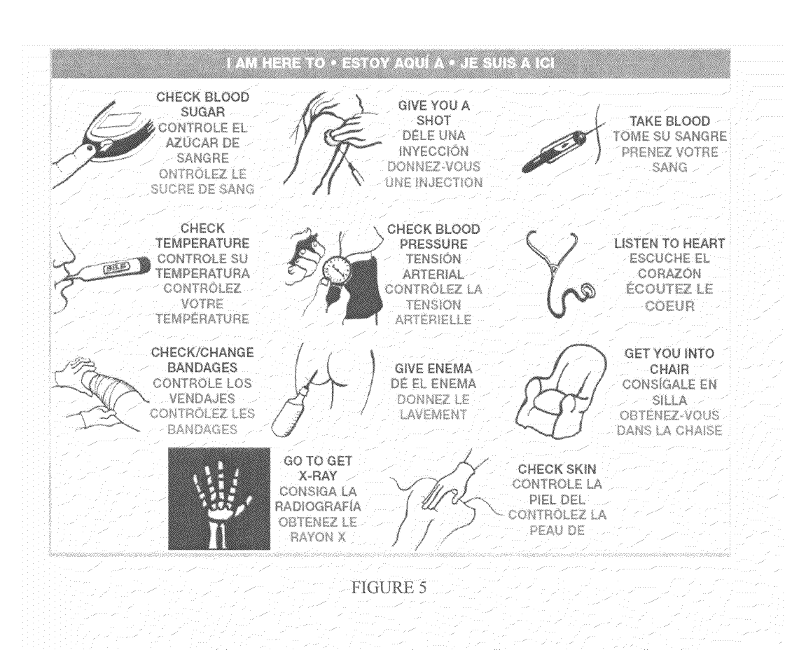

FIG. 5 provides an example in which the key communication is “I am here to”, and the graphics and text provide instructions that a healthcare provider can show a patient so the patient can understand the action that will be undertaken by the healthcare provider. Exemplary actions include checking blood pressure of a patient or giving the patient a shot. Other exemplary actions are provided in FIG. 5.

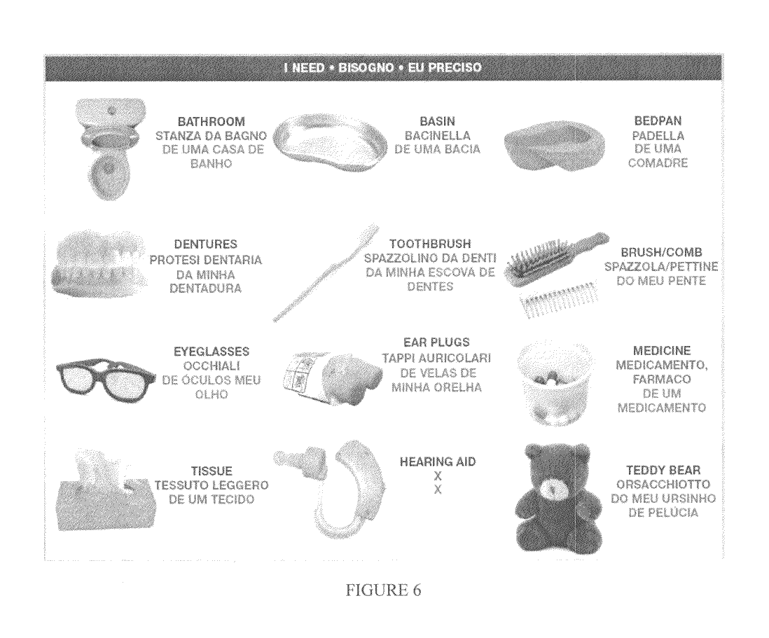

FIG. 6 provides an example in which the key communication is “I need”, and the graphics and text provide food, drink, or objects (such as medicine, medical device, television, stuffed animal) that the patient needs.

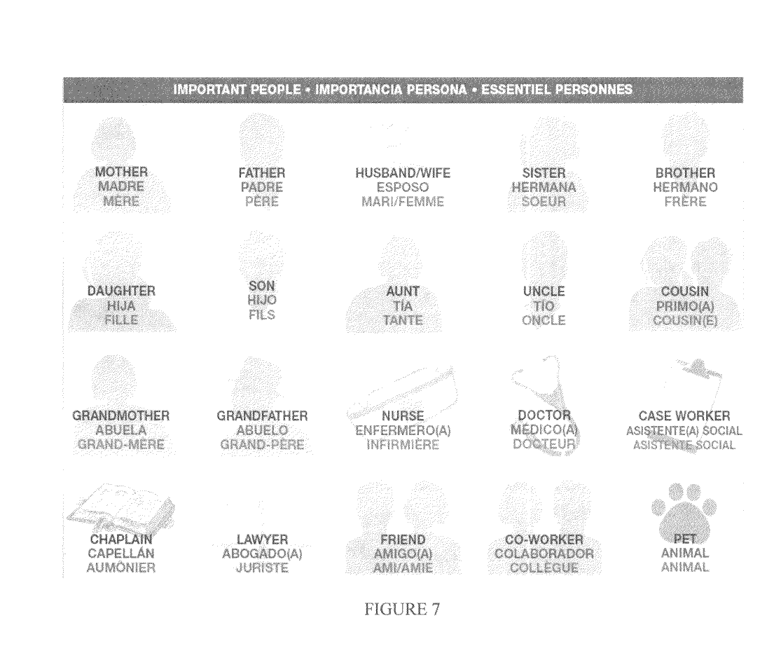

FIG. 7 provides an example in which the key communication is “Important people”, and the graphics and text provide people that are important to the patient, such as mother, father, or children. Other exemplary important people are provided in FIG. 7.

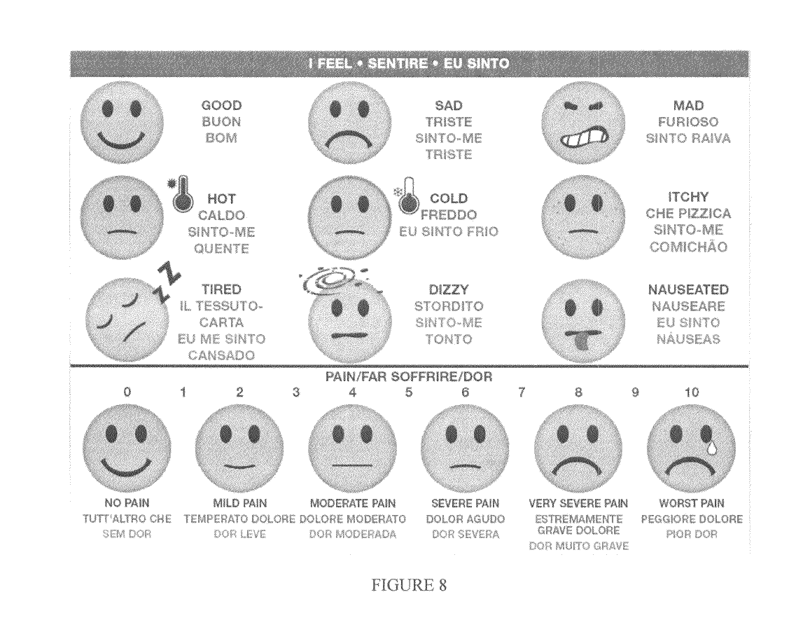

In certain embodiments, products of the invention include a fourth portion having a pain scale (FIG. 8). The pain scale may include an ascending set of numbers, generally from zero to ten, with zero representing no pain and ten representing the worst pain. A set of graphics is provided that corresponds with the numerical pain designations. In certain embodiments, the graphics are different faces, with each face having a facial expression that corresponds to a certain level of pain. The pain scale may also include text that corresponds with the different facial expressions. For example, a numerical designation of zero corresponds with a graphic that is a smiley face and text that states “no pain”. A numerical designation of 6 corresponds with a graphic that is a frowning face and text that states “severe pain”. A numerical designation of 10 corresponds with a graphic that is a frowning face with a tear and text that states “worst pain”.

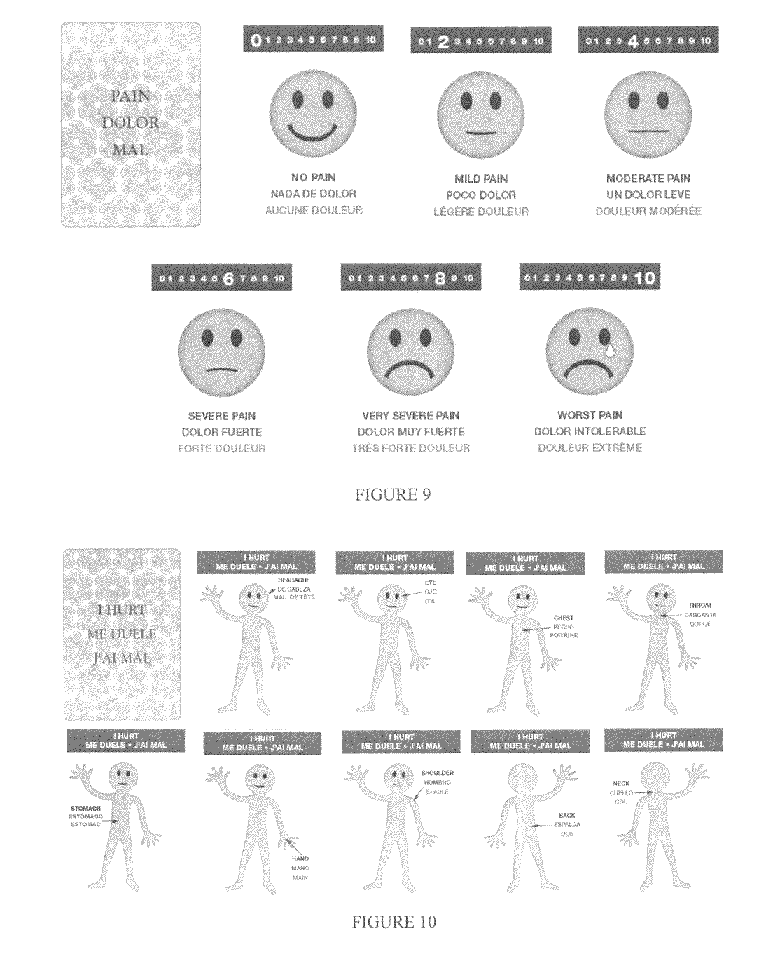

In certain embodiments, the pain scale is provided as a set of cards or a series of different screen shots, with each card/screen shot representing a different level of pain that the patient may be experiencing (FIG. 9). Each card/screen shot includes the ascending set of numbers, with a particular number emphasized (bold and enlarged in this embodiment) that corresponds to a pain level. Each card includes a graphic that corresponds to the pain level and text that corresponds to the graphic.

In certain embodiments, the products of the invention are provided as a set of cards/screen shots, each card/screen shot providing different information to facilitate communication between a healthcare provider an a patient. FIG. 10 shows an exemplary set of cards/screen shots related to pain being experienced by different parts of the body. The first card/screen shot provides the key communication “I hurt”. The next set of cards/screen shots include a graphic of a human body with an arrow pointing to a particular anatomical structure of the body and text that corresponds with that anatomical structure. A healthcare provider can move through the cards/screen shots until a patient identifies the part of the body in which they are experiencing pain. Such cards/screen shots can be used in combination with the pain cards/screen shots. For example, after a patient identifies the body part that hurts, the patient may be shown the pain cards/screen shots and they can identify the amount of pain they are experiencing.

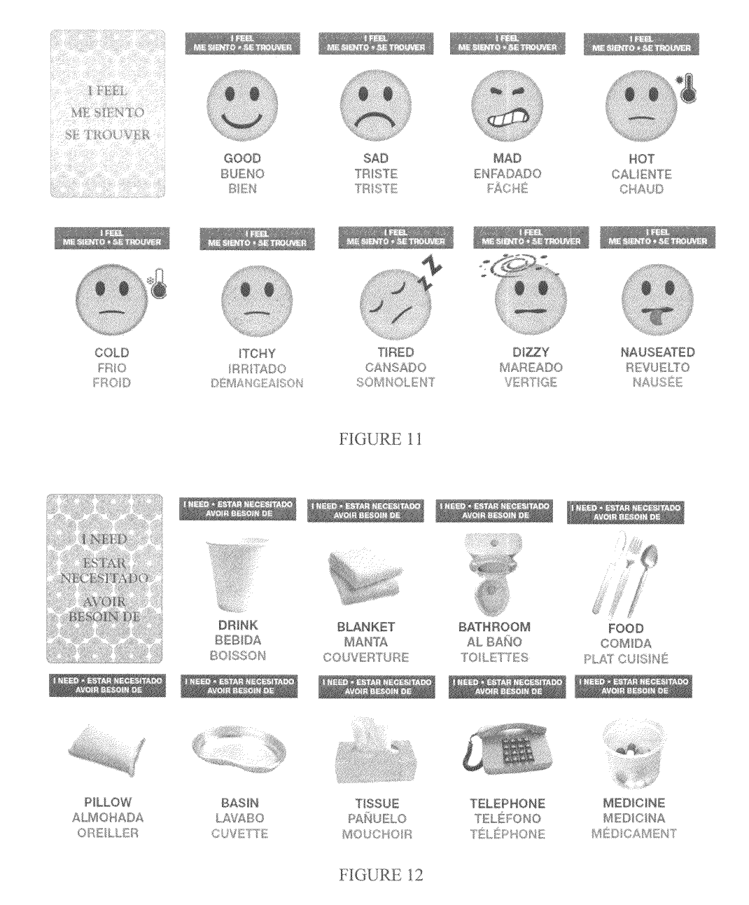

FIG. 11 shows an exemplary set of cards/screen shots related to overall state of being experienced by the patient. The first card/screen shot provides the key communication “I feel”. The next set of cards/screen shots include a graphic of a face having different facial expressions and text that corresponds to the facial expression. A healthcare provider can move through the cards/screen shots until a patient identifies the state of being that they are experiencing.

FIG. 12 shows an exemplary set of cards/screen shots related to things that may be needed by a patient. The first card/screen shot provides the key communication “I need”. The next set of cards/screen shots include different things that may be needed by a patient. A healthcare provider can move through the cards/screen shots until a patient identifies the thing they need.

Products of the invention may be configured such that more than one language is provided with each product (See FIGS. 1-12). For example, FIG. 1 shows that key communication 101 and corresponding text 103 may be provided in English, Spanish, and French. Products of the invention may be provided in more or less languages, and products of the invention are not limited to a certain language or a particular set of languages.

In embodiments, in which the product is a paper product, the paper product may be laminated so that it may be sterilized as required. Additionally, the product may include at least one member for attaching the product to an object in a patient's room (e.g., hooks, Velcro, straps, clips, or a lanyard).

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein.

What is claimed is:

1. A medical information product, the product comprising:
a first portion comprising a key communication;
a second portion comprising at least one graphic; and
a third portion comprising text that corresponds to the graphic;
wherein the key communication, the graphic, and the corresponding text facilitates communication between a healthcare provider and a patient.

2. The product according to claim 1, wherein the product is in paper form.

3. The product according to claim 1, wherein the product is an electronic display device.

4. The product according to claim 1, wherein the first and third portions are provided in a plurality of languages.

5. The product according to claim 1, wherein the key communication is a phrase selected from the group consisting of: I need; I want; I feel; I'm here to; I hurt; Important people; I must; and I must not.

6. The product according to claim 1, wherein the graphic is informative of the patient's state of being.

7. The product according to claim 6, wherein the graphic is a face having a certain expression that is informative of the patient's state of being.

8. The product according to claim 1, wherein the graphic is a patient's body part and is informative regarding a state of the body part.

9. The product according to claim 1, wherein the graphic is illustrative of a task that the healthcare provider would like the patient to undertake or refrain from doing.

10. The product according to claim 1, wherein the graphic is illustrative of a medical procedure that the healthcare provider would like to perform on the patient.

11. The product according to claim 1, wherein the graphic is illustrative of a something needed by the patient.

12. The product according to claim 1, wherein the graphic is illustrative of an important person in the patient's life.

13. The product according to claim 1, further comprising a fourth portion comprising a pain scale.

14. The product according to claim 13, wherein the pain scale comprises:
an ascending set of numbers;
a plurality of graphics; wherein each graphic correlates with an amount of pain being experienced by the patient; and
text that corresponds to the graphic.

15. The product according to claim 14, wherein the text is provided in a plurality of languages.

16. The product according to claim 14, wherein the graphic is a face having an expression that is informative of the patient's state of pain.

17. The product according to claim 1, wherein the product is laminated.

18. The product according to claim 1, further comprising at least one member for attaching the product to an object in a patient's room.

19. A computer program product for facilitating communication between a healthcare provider and a patient, the computer program product being embodied in a computer readable medium and comprising computer instructions to be executed by a processor to generate a visual display that comprises:
a first portion comprising a key communication;
a second portion comprising at least one graphic; and
a third portion comprising text that corresponds to the graphic;
wherein the key communication, the graphic, and the corresponding text facilitates communication between a healthcare provider and a patient.

20. The computer program product according to claim 19, wherein the first portion and the third portion are displayed in a plurality of different languages.

21. The computer program product according to claim 19, wherein the key communication is a phrase selected from the group consisting of: I need; I want; I feel; I'm here to; I hurt; Important people; I must; and I must not.

22. The computer program product according to claim 19, wherein the graphic is informative of the patient's state of being.

23. The computer program product according to claim 22, wherein the graphic is a face having a certain expression that informative of the patient's state of being.

24. The computer program product according to claim 19, wherein the graphic is a patient's body part and is informative regarding a state of the body part.

25. The computer program product according to claim 19, wherein the graphic is illustrative of a task that the healthcare provider would like the patient to undertake or refrain from doing.

26. The computer program product according to claim 19, wherein the graphic is illustrative of a medical procedure that the healthcare provider would like to perform on the patient.

27. The computer program product according to claim 19, wherein the graphic is illustrative of a something needed by the patient.

28. The computer program product according to claim 19, wherein the graphic is illustrative of an important person in the patient's life.

29. The computer program product according to claim 19, further comprising a fourth portion comprising a pain scale.

30. The computer program product according to claim 19, wherein the display further comprises a fourth portion comprising a pain scale.

31. The computer program product according to claim 30, wherein the pain scale comprises:
an ascending set of numbers;
a plurality of graphics; wherein each graphic correlates with an amount of pain being experienced by the patient; and
text that corresponds to the graphic.

32. The computer program product according to claim 31, wherein the text is provided in a plurality of languages.

33. The computer program product according to claim 31, wherein the graphic is a face having an expression that is informative of the patient's state of pain.

34. A method for facilitating communication between a patient and a healthcare provider, the method comprising:
showing a patient a medical information product, the medical information product comprising a first portion comprising a key communication; a second portion comprising at least one graphic; and a third portion comprising text that corresponds to the graphic, wherein the key communication, the graphic, and the corresponding text facilitates communication between a healthcare provider and a patient; and
using the product to facilitate communication between a healthcare provider and a patient.

35. The method according to claim 34, wherein the medical information product is in paper form.

36. The method according to claim 34, wherein the medical information product is an electronic display device.

37. The method according to claim 34, wherein the first and third portions are provided in a plurality of languages.

38. The method according to claim 34, wherein the key communication is a phrase selected from the group consisting of: I need; I want; I feel; I'm here to; I hurt; Important people; I must; and I must not.

39. The method according to claim 34, wherein the graphic is informative of the patient's state of being.

40. The method according to claim 39, wherein the graphic is a face having a certain expression that is informative of the patient's state of being.

41. The method according to claim 34, wherein the graphic is a patient's body part and is informative regarding a state of the body part.

42. The method according to claim 34, wherein the graphic is illustrative of a task that the healthcare provider would like the patient to undertake or refrain from doing.

43. The method according to claim 34, wherein the graphic is illustrative of a medical procedure that the healthcare provider would like to perform on the patient.

44. The method according to claim 34, wherein the graphic is illustrative of a something needed by the patient.

45. The method according to claim 34, wherein the graphic is illustrative of an important person in the patient's life.

46. The method according to claim 34, further comprising a fourth portion comprising a pain scale.

47. The method according to claim 34, wherein the display further comprises a fourth portion comprising a pain scale.

48. The method according to claim 47, wherein the pain scale comprises:
an ascending set of numbers;
a plurality of graphics; wherein each graphic correlates with an amount of pain being experienced by the patient; and
text that corresponds to the graphic.

49. The method according to claim 48, wherein the text is provided in a plurality of languages.

50. The method according to claim 48, wherein the graphic is a face having an expression that is informative of the patient's state of pain.
